(19) United States
(12) Patent Application Publication
(10) Pub. No.: US 2013/0062009 A1
(43) Pub. Date: Mar. 14, 2013

(54) THREE-DIMENSIONAL IMAGE OUTPUT APPARATUS

(71) Applicants: YU-CHOU YEH, TAOYUAN COUNTY (TW); CHAO-YI WANG, TAOYUAN COUNTY (TW); WEN-CHIH LO, TAOYUAN COUNTY (TW); TSUNG-HER YEH, NEW TAIPEI CITY (TW); TING-CHING LIN, NEW TAIPEI CITY (TW); SU-YING CHEN, TAOYUAN COUNTY (TW)

(72) Inventors: YU-CHOU YEH, TAOYUAN COUNTY (TW); CHAO-YI WANG, TAOYUAN COUNTY (TW); WEN-CHIH LO, TAOYUAN COUNTY (TW); TSUNG-HER YEH, NEW TAIPEI CITY (TW); TING-CHING LIN, NEW TAIPEI CITY (TW); SU-YING CHEN, TAOYUAN COUNTY (TW)

(73) Assignee: J TOUCH CORPORATION, TAOYUAN COUNTY (TW)

(21) Appl. No.: 13/290,255

(22) Filed: Nov. 7, 2011

(30) Foreign Application Priority Data
Sep. 14, 2011 (TW) 100217174

(51) Int. Cl. B32B 38/14

(52) U.S. Cl. 156/277

(57) ABSTRACT

Disclosed is a three-dimensional image output apparatus. The apparatus is designed to output 3D image product. The apparatus includes an image retrieving unit for retrieving at least one first image, and a lens membrane conveying unit for delivering at least one lens membrane. The lens membrane has a glue layer and a protective membrane is adhered thereon. The apparatus includes a printing unit for printing out a product for appearing 3D first image by looking at a second image through lens membrane. The apparatus includes a membrane removing unit for removing the protective membrane, a paving unit for paving the lens membrane onto the product, and an adhering unit for combining lens membrane with the product. The final product is then formed. A control unit is configured to control those units for achieving the production of 3D image, by which the first image is converted to the second image.

### BACKGROUND OF THE INVENTION

1. Field of the Invention

The instant disclosure is related to a three-dimensional image output apparatus, more particularly to the apparatus used for producing an end product with 3D image.

2. Description of Related Art

The conventional 3D (Three-Dimensional) display technology may be essentially classified into two types, namely a naked-eye (glasses-free) type and a glasses-type 3D displays.

The naked-eye types of 3D display allows the viewer to watch 3D scene without any extra device. In which, an additional optical lens is incorporated to an image or display panel for dividing the image data into left and right portions. Parallax barrier and Lenticular lens are two major technologies for the naked-type 3D display. The Lenticular lens technology means a Lenticular lens is inserted in front of the image or LCD panel, and the data for left and right eyes are separated. That means a theory of light refraction is applied to provide data to left and right eyes through the Lenticular lens separately. A 3D image is therefore projected onto the human eyes.

More, in practice, the 3D display technology using the Lenticular lens uses the printing technologies including a thermal transferring, a thermal sublimation, or the like. A 3D image is directly printed onto the Lenticular lens. A protective membrane is then coated thereon.

The machine for generating the 3D product with Lenticular lens has been developed, however the proprietary printing facilities are required since the related consumables are not so widespread. The facilities, such as UV printer, may cause high cost, and the relevant technology need to be improved.

The other method (second) is to directly adhere the lens membrane 10 with the Lenticular lens onto a carrier 11 having an image. The carrier 11 may be surface of a photograph film or a printing paper. Reference is made to FIG. 1, a cross-sectional diagram schematically shows the 3D product made by the mentioned second method. However, there is no device being developed in the market yet.

### SUMMARY OF THE INVENTION

In view of the conventional technology lacking of a 3D image output apparatus suitably for the masses, disclosed herein is a 3D image output apparatus used for producing a 3D image product.

In accordance with one embodiment of the invention, the 3D image output apparatus includes an image retrieving unit, a lens membrane conveying unit, a printing unit, a membrane removing unit, a paving unit, an adhering unit, and a control unit. In the embodiment, the image retrieving unit retrieves at least one first image; the lens membrane conveying unit conveys at least one lens membrane with a glue layer and a protective membrane is adhered thereon; and the printing unit prints out the printed matter with a second image and the 3D image of the first image is viewed by looking at the second image through the lens membrane. Further, in the apparatus, the membrane removing unit removes the protective membrane on the surface of the lens membrane; the paving unit paves the lens membrane from the membrane removing unit onto surface of the printed matter; and the adhering unit adheres the lens membrane with the printed matter obtained from the paving unit, so as to produce the 3D image product. The control unit is also included for controlling the image retrieving unit, the lens membrane conveying unit, the printing unit, the membrane removing unit, the paving unit, and the adhering unit. The control unit transforms the first image to the second image.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 schematically shows a cross-sectional diagram of a 3D image product;

FIG. 2 shows a schematic diagram of a 3D image output apparatus in accordance with the present invention;

FIG. 3 shows one further embodiment of the 3D image output apparatus in accordance with the present invention.

### DETAILED DESCRIPTION OF THE PREFERRED EMBODIMENTS

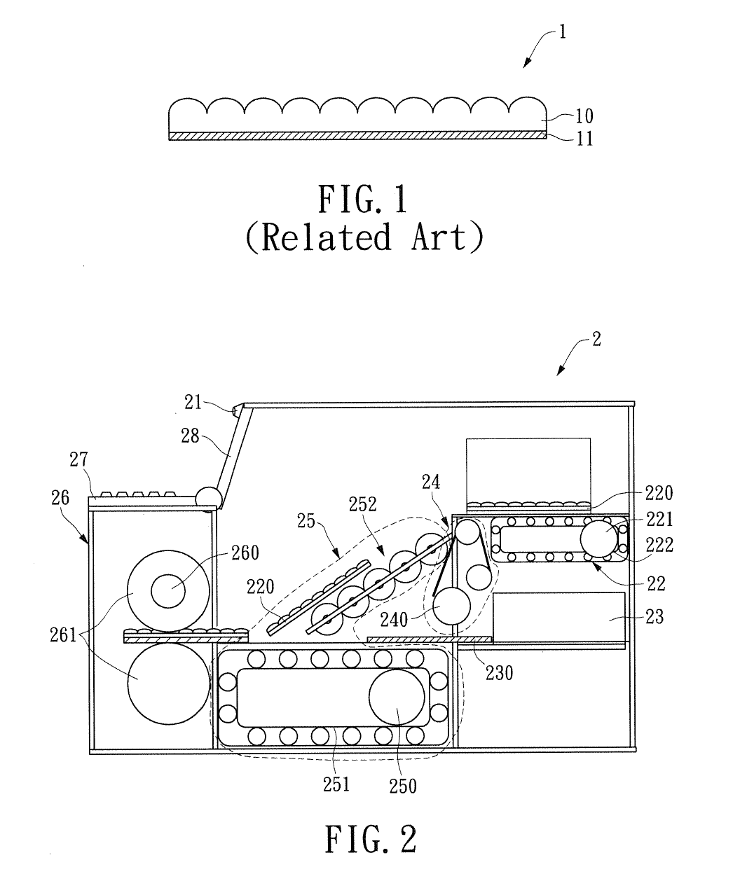

Reference is made to FIG. 2 showing one embodiment of the 3D image output apparatus in accordance with the present invention. One of the objectives of the 3D image output apparatus 2 is to produce a 3D image product 1 shown as the article in FIG. 1. Based on the functionalities provided by the apparatus 2, the apparatus 2 includes an image retrieving unit 21, a lens membrane conveying unit 22, a printing unit 23, a membrane removing unit 24, a paving unit 25, an adhering unit 26, and a control unit 27.

The image retrieving unit 21 is used to retrieves at least one first image at earlier stage. The image retrieving unit 21 may be a camera, such as a flat camera which is used to take two or more flat pictures from a left viewing angle and a right viewing angle respectively. Alternatively, a three-dimensional camera may also be employed to take the left and right pictures with a specific parallax since the pictures have an overlapped area. The image retrieving unit 21 may be a storage medium, such as a memory card, which stores the pictures.

The lens membrane conveying unit 22 is used to convey at least one lens membrane 220. The lens membrane 220 includes a glue layer (not shown in the diagram). A protective membrane (not shown) is further adhered onto the surface of the glue layer. The lens membrane conveying unit 22 includes a first motor 221 and a first conveying belt 222. In which, the first motor 221 is used to drive the first conveying belt 222. Through the operations of the first motor 221 and the first conveying belt 222, the lens membrane 220 can be next delivered to the membrane removing unit 24.

The printing unit 23 is used to print out a printed matter 230 having a second image. The 3D image of the first image is viewed by looking at the second image through the lens membrane 220. The fabrication of the second image is described as follows.

The membrane removing unit 24 is used to remove the protective membrane upon the surface of lens membrane 220. Then the adhesive glue layer is left on the surface of the lens membrane 220. The membrane removing unit 24 further includes a third motor 240, a peeling tape (not labeled in the diagram), and a roll set (not labeled). By which, the protective membrane can be removed and collected.

The paving unit 25 paves the lens membrane 220 from the membrane removing unit 24 onto the surface of the printed matter 230. The paving unit 25 includes a second motor 250, a second conveying belt 251, and a roll set 252. The roll set 252 is particularly used to convey the lens membrane 220 from the membrane removing unit 24. The second conveying belt 251 is then used to convey the printed matter 230. The second motor 250 is used to drive the second conveying belt 251.

The adhering unit 26 is used to combine the lens membrane 220 with the printed matter 230 from the paving unit 25, so as to produce a 3D image product 1. The adhering unit 26 also includes a fourth motor 260 and at least one roll set 261. In which, the fourth motor 260 drives the roll set 261.

In accordance with the present embodiment, the shown two rolls 261 jointly presses the printed matter 230 paved with the lens membrane 220. The adhesive lens membrane 220 and the printed matter 230 can be closely combined. It is noted that the present invention is not limited to this embodiment since the pressing process may be implemented by a set of a roll and a platform.

The control unit 27 is used to control the operations made by collaboration of the image retrieving unit 21, the lens membrane conveying unit 22, the printing unit 23, the membrane removing unit 24, the paving unit 25, and the adhering unit 26. The control unit 27 also transforms the first image(s) to the second image. Furthermore, there are various methods to implement the control unit 27 transforming the one or more flat images, i.e. the first images, to the second image. One of the simplest methods is to provide an interpolation calculation performed on two flat pictures respectively taken from left and right viewing angles. The second image is therefore produced. The 3D image of the first images can be viewed by looking at the second image through the lens membrane 220. It is also noted that the present invention is not limited to the present method.

The apparatus shown in FIG. 2 further includes a display unit 28, which is controlled by the control unit 27. The display unit 28 may be implemented as a monitor to display the manipulation during the above process, or as a display to preview the 3D image.

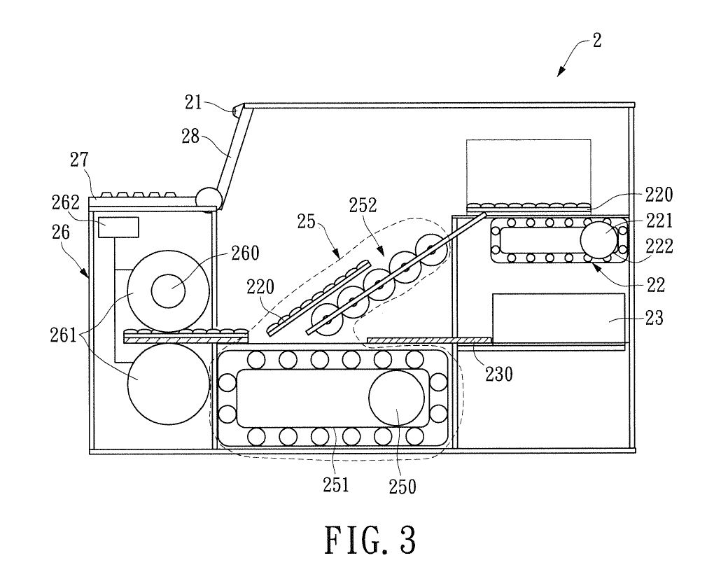

Reference is also made to FIG. 3 showing one further embodiment of the 3D image output apparatus in accordance with the present invention.

The elements shown in FIG. 3 are labeled as the embodiment described in FIG. 2 since they have approximate designs. It is featured that, rather than FIG. 2, the embodiment shown in FIG. 3 omits the membrane removing unit (24). In FIG. 3, the adhering unit 26 is introduced with a heater 262. The lens membrane 220 is provided with a hot-melting glue layer. This hot-melting glue layer may be selected from the compositions of polyethylene (PE), polyvinylchloride (PVC), polyvinylidene chloride (PVDC), polyvinyl acetate (PVA; PVAC).

In FIG. 3, the lens membrane 220 may lose its viscosity under a room temperature since the lens membrane 220 is equipped with the hot-melting glue layer. That means the present embodiment may omit the membrane removing unit 24 while the protective membrane is no more needed. Nevertheless, the hot-melting glue layer will have its own viscosity under a higher temperature. The adhering unit 26 is therefore added with the heater 262. The heater 262 is joined to the roll set 261, and heat can be transferred to the roll set 261 by means of principle of thermal conductivity. Thus the roll set 261 may perform heat pressing onto the printed matter 230 paved with the lens membrane 220. The 3D image product 1 is therefore made.

Through the above description related to the 3D image output apparatus, the claimed apparatus is in compliance with the requirements with novelty and non-obviousness as well as high applicability and low fabrication cost.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A 3D image output apparatus for producing a 3D image product, comprising:
an image retrieving unit, for retrieving at least one first image;
a lens membrane conveying unit, for conveying at least one lens membrane, wherein the lens membrane includes a glue layer, and a protective membrane is adhered onto surface of the glue layer;
a printing unit, for printing out a printed matter having a second image, wherein a 3D image of the first image is viewed by looking at the second image through the lens membrane;
a membrane removing unit, for removing the protective membrane from surface of the lens membrane;
a paving unit, for paving the lens membrane from the membrane removing unit onto the surface of the printed matter;
an adhering unit, for adhering the lens membrane with the printed matter from the paving unit, so as to form the 3D image product; and
a control unit, for controlling operations of the image retrieving unit, the lens membrane conveying unit, the printing unit, the membrane removing unit, the paving unit, and the adhering unit, and transforming the first image to the second image.

2. The apparatus of claim 1, wherein the image retrieving unit is a camera.

3. The apparatus of claim 1, wherein the lens membrane conveying unit includes a first motor and a first conveying belt, and the first motor is used to drive the first conveying belt.

4. The apparatus of claim 1, wherein the paving unit includes a second motor, a second conveying belt, and a roll set, and the roll set is used to convey the lens membrane from the membrane removing unit, the second conveying belt is used to convey the printed matter, and the second motor is used to drive the second conveying belt.

5. The apparatus of claim 1, wherein the membrane removing unit includes a third motor.

6. The apparatus of claim 1, wherein the adhering unit includes a fourth motor and at least one roll, and the fourth motor is used to drive the roll.

7. The apparatus of claim 1, further comprising a display unit, which is controlled by the control unit.

8. A 3D image output apparatus, for producing a 3D image product, comprising:
an image retrieving unit, for retrieving at least one first image;
a lens membrane conveying unit, for conveying at least one lens membrane, wherein the lens membrane includes a hot-melting glue layer;
a printing unit, for printing out a printed matter with a second image, wherein a 3D image of the first image is viewed by looking at the second image through the lens membrane;
a paving unit, for paving the lens membrane from the lens membrane conveying unit onto surface of the printed matter;
an adhering unit, for adhering the lens membrane with the printed matter from the paving unit, so as to form the 3D image product; and
a control unit, for controlling operations of the image retrieving unit, the lens membrane conveying unit, the printing unit, the paving unit, and the adhering unit, and transforming the first image to the second image.

9. The apparatus of claim 8, wherein the image retrieving unit is a camera.

10. The apparatus of claim 8, wherein the lens membrane conveying unit includes a first motor and a first conveying belt, and the first motor is used to drive the first conveying belt.

11. The apparatus of claim 8, wherein the paving unit includes a second motor, a second conveying belt, and a roll set, and the roll set conveys the lens membrane from the lens membrane conveying unit, the second conveying belt conveys the printed matter, and the second motor drives the second conveying belt.

12. The apparatus of claim 8, wherein the adhering unit includes a heater, a fourth motor, and at least one roll, and the fourth motor is used to drive the roll, which is joined to the heater.

13. The apparatus of claim 8, further comprising a display unit being controlled by the control unit.
